(19) United States
(12) Patent Application Publication
(10) Pub. No.: US 2012/0042980 A1
(43) Pub. Date: Feb. 23, 2012

(54) Reinforced Flexible Hose with High Pressure Strength and Method for its Manufacturing

(75) Inventors: Alessandro Mezzalira, Arcignano di Sondrigo (VI) (IT); Valentino Vigolo, Caldogno (VI) (IT); Giovanni Nelti, Padova (IT); Giulio Bergamo, Vicenza (IT); Alessandro Cegalin, Monteviale (VI) (IT)

(73) Assignee: FITT S.P.A., Sandrigo (VI) (IT)

(21) Appl. No.: 13/260,528

(22) PCT Filed: May 12, 2010
(86) PCT No.: PCT/IB2010/052119

§ 371 Date: Sep. 26, 2011

(30) Foreign Application Priority Data
May 12, 2009 (EP) 09006398.3
Jul. 22, 2009 (IT) VI2009A000184

(51) Int. Cl. F16L 11/02; F16L 11/08

(52) U.S. Cl. 138/137; 156/149

(57) ABSTRACT

A flexible hose, as viewed from the inside, includes at least one first inner layer made of a first thermoplastic polymer material, at least one reinforcement layer composed of a plurality of yarns knitted together to form a plurality of stitches of tricot type, and at least one second layer made of a second thermoplastic polymer material. At least one first yarn of the yarns that form the at least one reinforcement layer is a high tenacity fiber and at least one second yarn is a polyester fiber yarn or the like interwoven with the first yarn. A method of making such hose.

### FIELD OF THE INVENTION

The present invention generally finds application in the field of flexible hoses, and particularly relates to a high pressure reinforced flexible hose, particularly for irrigation.

The invention further relates to a method of making such hose.

### BACKGROUND ART

Flexible hoses generally have an inner layer or substrate, an outer layer or cover or skin, and at least one reinforcement layer, composed of a plurality of yarns.

The reinforcement layer may be of meshed type, in which the yarns are in overlapped relation to form a mesh, or of knitted type, in which the yarns are knitted together to form chain stitches, also known as tricot stitches. Such prior art reinforcements are generally made of polyester, polyethylene, polyurethane or the like fiber yarns.

Knitted reinforcements are known to have greater malleability and kink-resistance than meshed reinforcements. On the other hand, considering the same length of yarn, a meshed reinforcement involves lower manufacturing costs and has a higher pressure resistance than a knitted reinforcement.

Therefore, when a hose is designed to carry fluids at relatively high pressures, e.g. to about 15 bar, a meshed reinforcement is typically used, but this will involve drawbacks in terms of kinking and poor malleability of the hose.

On the other hand, when the hose is required to exhibit high resistance to internal pressures while maintaining malleability and kink-resistance, multiple overlapping knitted reinforcements are used. One example of this solution is known from European Patent EP-B1-1156252.

Nevertheless, this solution suffers from the recognized drawback of a difficult and expensive manufacture. Another drawback is that the manufacturing line for these hoses has a rather poor throughput, due to the time-consuming manufacture of the double knitted layer.

Another solution employed in the art to impart high internal pressure resistance to the hose, while maintaining relative malleability and kink-resistance consists in the use of a reinforcing spiral, also made of polyester or similar fibers, over- or under-lying the knitted layer (the so-called “spiral tricot” hose). An example of this solution is known from European Patent Application EP-A-0794377.

However, this is also an expensive, difficult and time consuming solution.

Hoses are further known which have a single or double reinforcement layer, at least one of them being knitted, which are aimed at combining malleability with high pressure and kink resistance, using high tenacity materials, such as aramid fibers.

For example, US 2001/39972 discloses an irrigation hose comprising a first spiral reinforcement layer and a second knitted layer overlying the former.

In a possible configuration, one of the layers is wholly made of materials having a higher tenacity than the materials that are commonly used for this purpose, e.g. polyester. Particularly, one of the possible suitable high-tenacity materials is Kevlar®.

The provision of a reinforcement layer wholly made of Kevlar® is not only poorly cost effective, but also has further technical drawbacks.

Once the substrate has been knitted, a reinforcement layer wholly made of a high tenacity fiber, such as aramid fibers, e.g. Kevlar® will not perfectly adhere to such substrate.

Therefore, the covering layer shall have a greater thickness than in the solutions with common fibers, such as of polyester type. Furthermore, there will never be an optimal adhesion between the substrate and the overlying layer, which will result in a poor quality hose.

### DISCLOSURE OF THE INVENTION

The object of the present invention is to at least partially overcome the above drawbacks, by providing a flexible hose that is highly efficient and relatively cost effective.

Another object of the invention is to provide a flexible hose that is relatively cost effective, ensures considerable high pressure resistance, relative malleability and minimizes kinking.

Another object of the invention is to provide a flexible hose that ensures considerable high pressure resistance and relative malleability, minimizes kinking and can be manufactured in a simple and quick manner.

Yet another object is to provide a high pressure flexible hose that also ensures a highly stable coupling of the tubular layers and can have a thin covering layer, thereby affording materials savings.

These and other objects, as better explained hereafter, are fulfilled by a flexible hose as defined in claim 1.

The flexible hose of the invention may comprise at least one first inner layer or substrate, made of a first thermoplastic polymer material, at least one reinforcement layer and at least one second outer or covering layer, or skin, made of a second thermoplastic polymer material.

Advantageously, the first and second thermoplastic polymer materials of the first and second layers respectively may be compatible.

As used herein, the term “compatible materials” or derivatives thereof shall be intended to indicate materials having a chemical and/or physical compatibility with each other, i.e. materials that, while in joined relationship, provide a junction adapted to support the transfer of tensile or shear stresses through the contact surface. The highest compatibility is thus achieved between identical materials or having the same matrix base.

Conveniently, the first and/or second polymer materials may all have a plasticized PVC (polyvinyl chloride) based matrix. Preferably, both materials may include a plasticized polyvinyl chloride based matrix.

As used herein, the term “matrix” of a polymer or derivatives thereof, shall be intended to indicate a polymer material that can provide the molecular structure of the final product.

As used herein, the term “-based matrix” or derivatives thereof, preceded by the name of a polymer material, shall be intended to indicate a polymer material capable of providing the molecular structure of the polymer material whose name precedes the term “-based matrix) to the final product.

The reinforcement layer may be composed of a plurality of yarns knitted together to form a plurality of chain stitches of the tricot type.

One or more of the yarns that form the reinforcement layer may be a high tenacity fiber, advantageously having a higher tenacity than the polyester fiber. Without being bound to any theory, it can be established that the polyester fiber has a tenacity of about 700-800 mN/tex.

Advantageously, the high tenacity fiber may have a tenacity of at least 1500 mN/tex. It was surprisingly found that, from this tenacity value on, the knitted reinforcement layer with tricot stitches imparts high internal pressure resistance to the hose.

In a preferred, non limiting embodiment, this high tenacity fiber may have a tenacity of at least 1800 mN/tex, preferably at least 2000 mN/tex and more preferably at least 2150 mN/tex.

This configuration will provide the high malleability and kink resistance of the tricot reinforcement layer, as well as a high internal pressure resistance, with relatively low process costs.

In contrast with the technical assumption that the knitted reinforcement has to be joined to another reinforcement, such as another knitted layer with tricot stitches, as disclosed in EP-B1-1156252, or a spiral reinforcement (the so-called spiral tricot hose), disclosed in EP-A-0794377 to increase the internal pressure resistance while maintaining malleability, the Applicant has conceived a highly malleable hose, that minimizes kinking, ensures high internal pressure resistance, and also allows less expensive and quicker manufacture as compared with the prior art.

The flexible hose of the invention will provide a considerable high pressure resistance, by using high tenacity fibers having a selected tenacity to impart high internal pressure resistance.

Furthermore, the hose of the invention will provide high malleability and minimized kinking, due to the at least one knitted reinforcement with tricot stitches.

Also, the hose of the invention will be manufactured in a cost-effective and quick manner because, under the same internal pressure resistance and malleability conditions, the manufacturing process involves the formation of one knitted reinforcement with tricot stitches instead of two reinforcements, unlike the above prior art hoses.

Conveniently, this at least one high-tenacity fiber may have physical and/or chemical properties allowing it to be knitted with the polyester fiber.

As used herein, the term “fiber” or derivatives, possibly preceded by the name of a material that constitutes it, is intended as the assembly of one or more fibrous products that are joined together by spinning or similar processes to form a yarn.

As used herein, unless otherwise stated, the term “tenacity” or derivatives shall be intended as the tenacity of a fiber according to the known EN ISO 2062 standard. Measurements may be preferably made at ambient temperature.

Preferably, such at least one high tenacity fiber may be selected from the group comprising aramid fibers, such as Kevlar®, Nomex® or Twaron®, high modulus polyethylene fibers, polyether ether ketone fibers (PEEK), carbon fiber, metal fibers, basalt fibers or hybrid fibers obtained by joining together two or more of them.

These materials differ in their elastic and/or tenacity properties and/or in their environmental and/or plastic collapse resistance properties.

Advantageously, at least one second yarn of the reinforcement layer is formed of a polyester fiber or a fiber of substantially equal tenacity. In other words, the textile reinforcement layer may be formed of one or more high tenacity fibers, e.g. Kevlar® and/or carbon fibers, and one or more polyester fibers or fibers of equal tenacity, in any amount.

Particularly, the second yarn made of a polyester fiber or a fiber of equal tenacity will be joined to at least one high tenacity yarn.

Particularly, the polyester yarn will overlap the high tenacity yarn at multiple locations, to form a single reinforcement layer in which the polyester or similar yarns will not be separable from high tenacity yarns, unlike prior art hoses, in which the Kevlar or the like layers are substantially independent of polyester layers.

Conveniently, the second yarn made of a polyester fiber or a fiber of equal tenacity will be knitted with the first high tenacity yarn.

The second yarn, made of a heat shrink material, will be adapted to put the first wire under tension to adhere the reinforcement layer to the underlying layer.

Polyester fibers, or fibers of equal tenacity, have higher heat shrink properties, whereby if a heat shrinking step is provided during manufacture, the polyester or similar fiber will tend to shrink and wrap the substrate, thereby putting the high tenacity fibers coupled thereto under tension.

As used herein, the term “heat shrink properties” will designate the ability of a material to shrink in response to heating by a heat source, to adhere to the underlying material.

Mutual coupling of polyester or similar yarns will force high tenacity fibers to also remain perfectly adherent to the substrate, thereby avoiding any separation of the reinforcement layer from the substrate and providing a thinner skin with improved adhesion to the substrate.

On the other hand, all the yarns of the first plurality may have the same tenacity as the first yarn and be high tenacity fibers having a tenacity of at least 1500 mN/tex. In other words, the textile reinforcement layer may include a first knitted portion that is wholly formed of high tenacity fibers, having a tenacity of at least 1500 mN/tex.

Preferably, one or more of these may have a tenacity of at least 1800 mN/tex, more preferably at least 2000 mN/tex and most preferably at least 2150 mN/tex.

In this configuration, the yarns may or not be identical, i.e. formed of the same fiber. For instance, the textile reinforcement layer may include a first knitted portion that is wholly formed of Kevlar® fibers, carbon fibers, or both Kevlar® and carbon fibers.

Advantageously, the reinforcement layer may include, in addition to the first plurality of yarns, a second plurality of yarns knitted together to form a second plurality of tricot chain stitches.

The yarns of this second plurality may define a second knitted portion of the reinforcement layer.

The yarns of this second plurality may have any tenacity and be formed of any fiber or groups of fibers.

Preferably, in a preferred, non limiting embodiment, the yarns of the second plurality are composed of polyester fibers or fibers of substantially equal tenacity.

The first and/or second pluralities of yarns may have substantially parallel wales and substantially parallel courses of tricot stitches.

The first and second knitted portions may be interlaced together. In this embodiment, the wales of a knitted portion may overlap the courses of the other knitted portion and vice versa.

In a particularly preferred embodiment, the first and/or second plurality of reinforcement yarns may be knitted with simple or double chain stitches, and may be formed in accordance with the teachings of patents EP-B1-0623776 or EP-B1-0960297, by the Applicant hereof.

Advantageous embodiments of the invention are defined in accordance with the dependent claims.

### BRIEF DESCRIPTION OF THE DRAWINGS

Further features and advantages of the invention will become more apparent from the detailed description of a few preferred, non exclusive embodiments of a flexible hose of the invention, which are described as non limiting examples with the help with the accompanying drawings in which:

FIG. 1 is a plan view of a first embodiment of the hose of the invention, with certain details omitted;

FIG. 2 is a plan view of a second embodiment of the hose of the invention, with certain details omitted;

FIG. 3 is a plan view of a third embodiment of the hose of the invention, with certain details omitted;

FIG. 4 is a plan view of a fourth embodiment of the hose of the invention, with certain details omitted;

FIG. 5 is a plan view of a fifth embodiment of the hose of the invention, with certain details omitted;

FIG. 6 is a schematic view of a hose manufacturing line of the invention.

### DETAILED DESCRIPTION OF A FEW PREFERRED EMBODIMENTS

Referring to the above figures, the flexible hose 1 of the invention may be a garden hose and be particularly used for irrigation, possibly for domestic watering.

The flexible hose 1 may comprise a first inner layer or substrate 2, made of a first thermoplastic polymer material, at least one reinforcement layer 3 and at least one second outer layer or skin, made of a second thermoplastic polymer material.

The first and second polymer materials that form the substrate 2 and the skin 4 respectively may include a plasticized PVC (polyvinyl chloride) based matrix.

Preferably, the inner layer 2 and the second layer 4 will be only separated by one or more reinforcement layers 3, at least one whereof is knitted.

Advantageously, both the first layer 2 and the second layer 4 may be formed by continuous extrusion of their respective thermoplastic materials.

Additional layers may be also provided in any arrangement, as is typical for this type of hoses, i.e. internal to the first layer 2 and/or external to the second layer 4.

The reinforcement layer 3 may comprise a first plurality of yarns 5, 51, 5′″, . . . knitted together to form a plurality of tricot stitches 6, 6′, 6′″ . . . .

At least one first yarn 5 of the yarns 5, 5′, 5′″, . . . of the first plurality may be a high tenacity fiber, preferably of the above mentioned type, and may have a tenacity of at least 1800 mN/tex, more preferably at least 2000 mN/tex, and most preferably at least 2150 mN/tex.

Suitably, more yarns of the first plurality may have the tenacity of the first yarn 5. Any number of such high tenacity yarns may be provided, e.g. two, three, four or eight.

According to the invention, the reinforcement layer 3 further includes at least one second yarn 5″ consisting of a polyester fiber or a fiber of comparable tenacity, coupled to at least the first yarn 5 or further yarns of the first plurality of high tenacity-type yarns.

In a preferred, non limiting configuration, in the reinforcement layer 3 the number of yarns having the same tenacity as the second yarn 5″ will be greater than the number of yarns having the same tenacity as the first yarn 5.

This will provide a reinforcement layer 3 with optimal adhesion to the substrate 2, as well as adequate resistance to the maximum pressures that may typically occur when using this kind of hose as irrigation hoses.

Nevertheless, the reinforcement layer 3 may be formed of any number of high tenacity fibers or polyester fibers or fibers of equal tenacity.

The textile reinforcement layer 3 may have substantially parallel wales 7, 7′, 7″, . . . and substantially parallel courses of tricot stitches 8, 8′, 8″, . . . .

In a particularly preferred embodiment, the reinforcement layer 3 may be formed in accordance with the teachings of patents EP-B1-0623776 or EP-B1-0960297, by the Applicant hereof.

Particularly, the reinforcement layer 3 may be spiraled over the bearing layer 2, with wales 7, 7′, 7″, . . . and courses of tricot stitches 8, 8′, 8″, . . . inclined to the longitudinal axis Y of the hose at respective predetermined inclination angles α, β.

The hose of the invention may also include a first knitted portion 3′ composed of the yarns 5, 5′, 5′″, . . . of the first plurality and a second knitted portion 3″ composed of a second plurality of yarns 10, 10′, 10″, 10′″, . . . knitted together with tricot stitches 11, 11′, 11″, 11′″ . . . .

The yarns 10, 10′, 10″, 10′″ . . . of this second plurality may have any tenacity and be formed of any number and type of yarns.

The second knitted portion 3″ may or not be configured like the first knitted portion 3′.

In a preferred non limiting embodiment, the second knitted portion 3″ of the reinforcement layer 3 may be also formed in accordance with the teachings of patents EP-B1-0623776 or EP-B1-0960297, by the Applicant hereof.

Particularly, the second knitted portion 3″ may be spiraled over the bearing layer 2, with courses of tricot stitches 12, 12′, 12″, . . . and wales 13, 13′, 13″, . . . inclined to the longitudinal axis of the hose at respective predetermined inclination angles α′, β′.

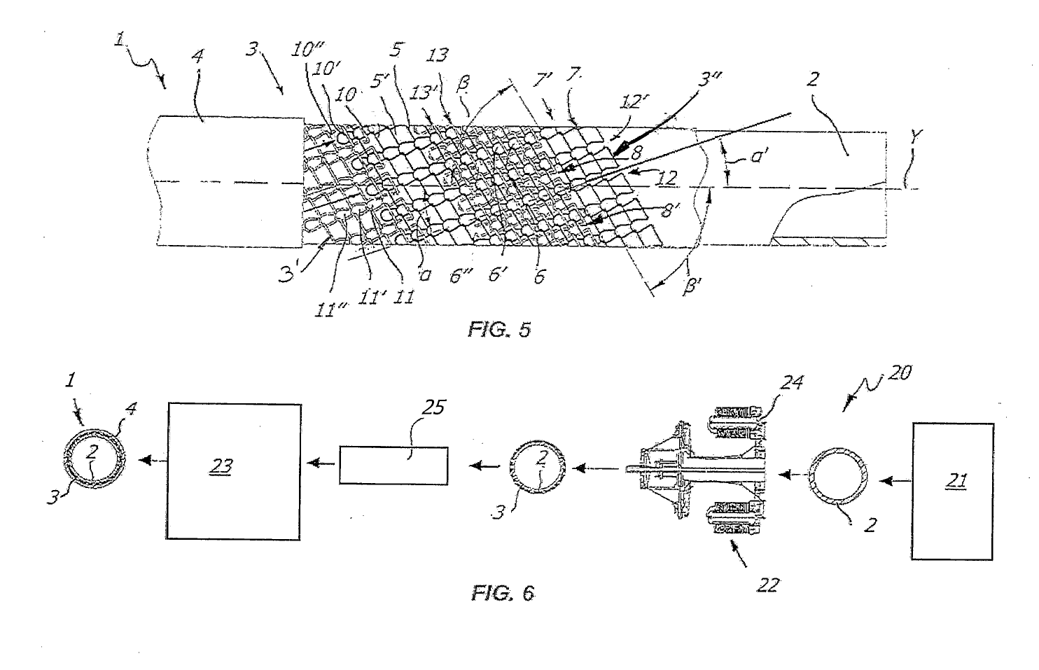

In a preferred embodiment, as shown in FIG. 5, the yarns 5, 5′, 5″ . . . of the first plurality will be of high tenacity type, i.e. will have the same tenacity as the first yarn 5, whereas the yarns of the second plurality will have the same tenacity as the second yarn 10.

The first 3′ and second 3″ knitted portions will be interlaced together, so that the wales 7, 7′, 1″ . . . of the first knitted portion 3′ overlap the courses of stitches 12, 12′, 12″ . . . of the second knitted portion 3″ and conversely, the wales 13, 13′, 13″, . . . of the second knitted portion 3″ overlap the courses 8, 8′, 8″, . . . of the first knitted portion 3′.

With this arrangement, a relatively large number of high tenacity fibers may be used in combination with lower tenacity fibers, without incurring the risk that, in case of particularly high pressures that cause the hose 1 to swell, the high tenacity fibers may cut the lower tenacity fibers, and thus affect the integrity of the reinforcement layer 3.

The hose 1 so obtained will have an even higher burst strength, with maximum values that may even reach 20 bar, i.e. considerably higher than typical peak values for common irrigation hose applications.

The hose 1 of the invention may be fabricated by the manufacturing line as shown in FIG. 6.

This line 20 will basically include a first extruder 21, one or more circular knitting machines 22 and a second extruder 23. Both the extruders 21, 23 and the circular knitting machine 22 may be of known type.

For instance, the knitting machine 22 may be of known type and configured so that the lines of stitches 8, 8′, 8″, . . . of the reinforcement layer 3 are parallel to the axis of the hose, or may be manufactured in accordance with the teachings of Italian patent IT1270776, to form knitted reinforcement layers spiraled over the bearing layer with tricot stitches, with parallel wales and courses of stitches having opposite inclinations.

As a rule, the process for manufacturing the hose 1 may include a first step of extrusion of the first polymer material, that may be introduced in granule form into the first extruder 21, to obtain the first inner layer or substrate 2, knitting of the reinforcement layer thereon by the knitting machine 22, and a second step of extrusion of the second polymer material on the semifinished product so obtained, which second material may be introduced in granule form into the second extruder 23, to form the second outer layer or cover 4. If the hose comprises a reinforced layer 3 with two knitted portions 3′, 3″, then two knitting machines 22 may be used, one for each of the portions 3′, 3″, possibly having opposed knitting heads.

As is known, the knitting machines 22 have a rotary spool supporting plate element 24, which supports the spools of the yarns 5, 5′, 5″, 5′″, . . . that are designed to form the reinforcement layer 3.

In order to form the latter, the spool supporting element 24 will be fitted with as many spools of high tenacity yarn on as many supports, to form the reinforcement layer 3, and the remaining supports will be fitted with the spools of polyester fiber or fiber of equal tenacity.

For instance, assuming that the spool supporting element 24 has eight supports, and that a flexible hose 1 is desired that has a reinforcement layer 3 with three high tenacity yarns and five polyester fiber yarns, the supports of the spool supporting element 24 shall be fitted with three spools of high tenacity yarn, e.g. Kevlar®, and five spools of polyester fiber or fiber of equal tenacity, and the machine shall be operated in a known manner, and possibly with yarn tension adjustment for proper knitting. Through a number of attempts, the skilled person will be able to find the right tension for proper knitting.

On the other hand, if the reinforcement layer 3 is required to have a first knitted portion 3′ in which all yarns are high tenacity yarns, the eight supports of the spool supporting element 24 shall be fitted with spools of high tenacity fiber, such as Kevlar®, and the process shall be carried out as above.

The spool supporting element 24 may have any number of spools, in any ratio of high tenacity yarn spools to polyester fiber spools or spools with fibers of equal tenacity.

In a particularly advantageous aspect of the invention, a local heating station 25 will be provided between the two extruding stations 21, 23 and downstream from the knitting machine 22, for heating the semifinished product comprising the first layer 2 and the knitted reinforcement layer 3.

By way of example, this station may include a tunnel kiln for continuous heating of the semifinished product, and particularly the knitted layer.

Thus, the yarns made of polyester or a similar material will expand and then, upon natural or forced cooling, will shrink over the first layer 2 to a greater extent than high tenacity fiber yarns.

This will put the latter under tension and cause them to adhere to the first layer 2, thereby ensuring optimal adhesion of the reinforcement layer 3 to the inner layer 2.

FIGS. 1 to 5 show non limiting embodiments of the invention. Particularly, the yarns may be of any nature and number without departure from the scope as defined in the annexed claims.

In the figures, high tenacity yarns or fibers are indicated by full lines, whereas the yarns made of polyester fiber or fiber of equal tenacity, are indicated by simple lines. In these embodiments, the succession of tricot stitches 6, 6′, 6″, 6′″, . . . will form the line 8, the underlying succession will form the line 8′, and so on.

In all these embodiments, high tenacity fibers may be selected, for example and without limitation, among the fibers of Table 1. Among them, a particularly preferred fiber is Kevlar®.

For each of the fibers in the table, a tenacity range is also indicated. It shall be noted that, as is known, the tenacity of a fiber depends on various conditions, and that a fiber that has been degraded, e.g. upon knitting thereof with other fibers in a knitting machine, like the circular knitting machine 22, may lose up to 30-40% of its initial tenacity.

TABLE 1

| Fiber | Tenacity, mN/tex |
|---|---|
| Kevlar fiber | 2000-2600 |
| Carbon fiber | 1500-2000 |
| High modulus polyethylene fiber | 3000-4000 |

FIG. 1 shows a first embodiment of a hose 1 of the invention, in which the yarns 5, 5′ are made of a high tenacity fiber and the yarns 5″, 5′″, . . . are made of a polyester fiber.

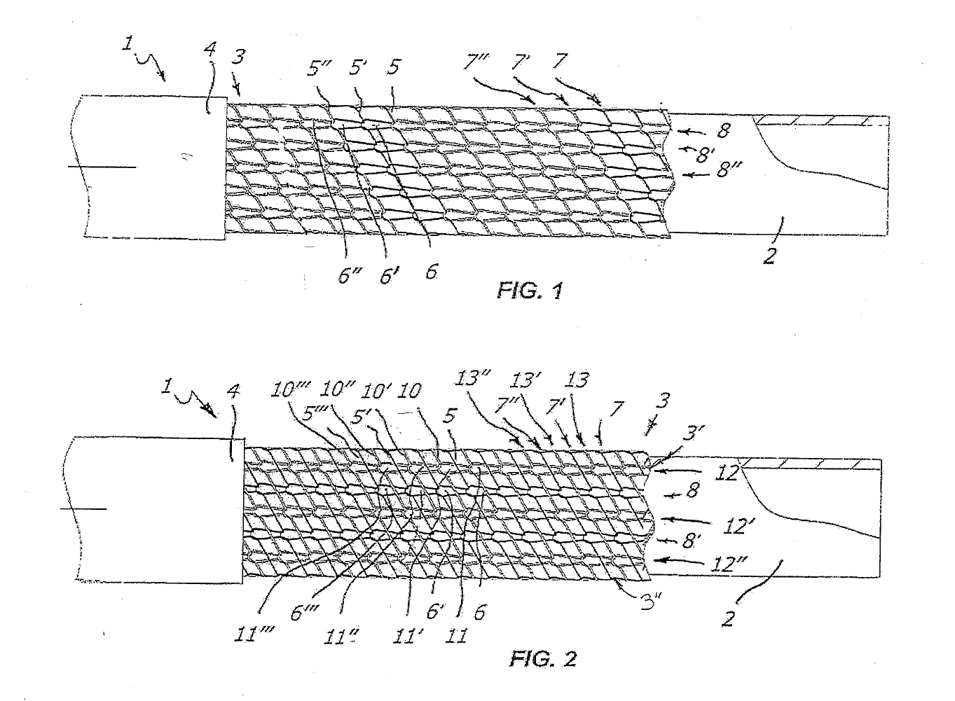

FIG. 2 shows a second embodiment of a hose 1 of the invention, which comprises a reinforcement layer 3, with a first plurality of yarns 5, 5′ . . . all made of high tenacity fibers, that constitutes the first knitted portion 3′, and a second plurality of yarns 10, 10′, 10″, 10′″ . . . , that constitutes the second knitted portion 3″, made of a polyester fiber or a fiber of equal tenacity.

The high tenacity yarns 5, 5′, 5′″, . . . of the reinforcement layer 3 form wales 7, 7′, 7″, 7′″, . . . and courses 8, 8′, 8″, . . . of stitches 6, 6′, 6″, 6′″, . . . , whereas the yarns 10, 10′, 10″, 10′″, . . . of polyester or similar fiber will form wales 13, 13′, 13″, . . . and courses 12, 12′, 12″, . . . of stitches 11, 11′, 11″, 11′″

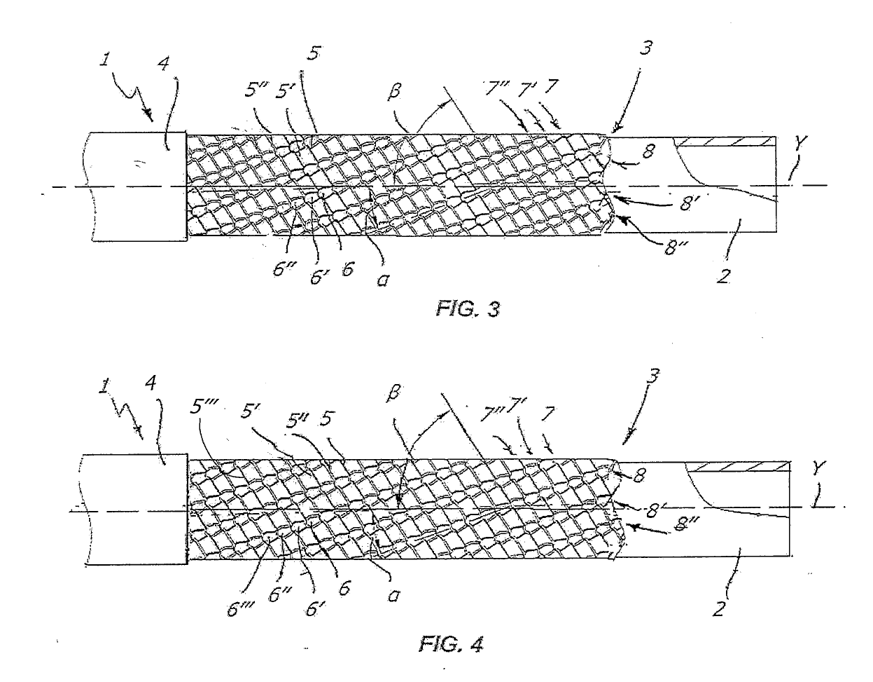

FIG. 3 shows a third embodiment of a hose 1 of the invention, in which the reinforcement layer 3 has high tenacity yarns 5, 5′, . . . and polyester fiber yarns 5″, 5′″, . . . . In this embodiment, the reinforcement layer 3 is spiraled over the bearing layer 2, with the courses of tricot stitches 8, 8′, 8″, . . . and the wales 7, 7′, 7″, . . . inclined to the longitudinal axis Y of the hose at respective predetermined inclination angles α, β. For this purpose, in this embodiment, the knitting machine 22 may be formed according to the teachings of Italian patent IT1270776.

FIG. 4 shows a fourth embodiment of a hose 1 of the invention, in which the yarns 5, 5′, . . . are made of a high tenacity fiber and the yarns 5″, 5′″, . . . are made of a polyester fiber. In other words, high tenacity yarns and polyester yarns are in alternate arrangement.

Also in this embodiment, the reinforcement layer 3 is spiraled over the bearing layer 2, with the courses of tricot stitches 8, 8′, 8″, . . . and the wales 7, 7′, 7″, . . . inclined to the longitudinal axis Y of the hose at respective predetermined inclination angles α, β.

For this purpose, also in this embodiment, the knitting machine 22 may be formed according to the teachings of Italian patent IT1270776.

FIG. 5 shows a fifth embodiment of a hose 1 of the invention, which comprises a reinforcement layer 3, with a first knitted portion 3′ in which the yarns 5, 5′, 5′″ . . . are all made of high tenacity fibers and a second knitted portion 3″, wholly made of a polyester fiber yarns 10, 10′, 10″, 10′″ . . . .

In this embodiment, both portions 3 and 3″ are spiraled over the underlying layer, with corresponding wales 8, 8′, 8″, . . . and courses 12, 12′, 12″, . . . of tricot stitches 6, 6′, 6″, 6′″, . . . and 11, 11′, 11″, 11′″, . . . and courses 7, 7′, 7″, . . . and 13, 13′, 13″, . . . inclined to the longitudinal axis Y of the hose at respective predetermined inclination angles α, β and α′, β′.

For this purpose, this embodiment may be implemented by two knitting machines 22 or a single knitting machine having two knitting heads, that may be formed in accordance with the teachings of Italian patent IT1270776.

The above description clearly shows that the invention fulfils the intended objects.

Particularly, the invention provides a flexible hose that may be manufactured in a relatively cost-effective, simple and quick manner, ensures considerable high pressure resistance and relative malleability and minimizes kinking.

The hose of the invention is susceptible of a number of changes and variants, within the inventive concept disclosed in the appended claims. All the details thereof may be replaced by other technically equivalent parts, and the materials may vary depending on different needs, without departure from the scope of the invention.

While the hose has been described with particular reference to the accompanying figures, the numerals referred to in the disclosure and claims are only used for the sake of a better intelligibility of the invention and shall not be intended to limit the claimed scope in any manner.

The invention claimed is:

1. A flexible hose comprising:
at least one inner layer (2) made of a first thermoplastic polymer material;
at least one reinforcement layer (3) comprising at least one first plurality of yarns (5, 5′, 5′″, . . . ) knitted together to form a first plurality of chain stitches (6, 6″, 6′″ . . . ) of tricot type; and
at least one second outer layer (4) made of a second thermoplastic polymer material;
wherein at least one first yarn (5) of said yarns (5, 5′, 5′″, . . . ) of said first plurality comprises a high tenacity fiber that has a tenacity of at least 1500 mN/tex, as measured according to EN ISO 2062 standard,
said at least one reinforcement layer comprising at least one second yarn (5″, 10) comprising a polyester fiber or a fiber of substantially equal tenacity, said second yarn (5″, 10) being fastened to said at least one first yarn (5) to keep said at least one first yarn adhering to said first inner layer (2).

2. The hose as claimed in claim 1, wherein said high tenacity fiber has a tenacity of at least 1800 mN/tex.

3. The hose as claimed in claim 1, wherein said at least one high tenacity fiber is selected from the group consisting of aramid fibers, high modulus polyethylene fibers, polyether ether ketone fibers, carbon fiber, metal fibers, basalt fibers, or hybrid fibers thereof.

4. The hose as claimed in claim 3, wherein said aramid fibers are selected from the group consisting of Kevlar®, Nomex® o Twaron®.

5. The hose as claimed in claim 1, wherein said at least one second yarn (5″) belongs to said first plurality and is knitted with said at least one first yarn (5).

6. The hose as claimed in claim 1, wherein all of the yarns (5, 5′, 5′″, . . . ) that form said first plurality have the same tenacity as said at least one first yarn (5), said reinforcement layer comprising a second plurality of yarns (10, 10′, 10″, 10′″, . . . ) knitted together to form a second plurality of tricot chain stitches (11, 11′, 11″, 11′″, . . . ), wherein all of the yarns (10, 10′, 10″, 10′″, . . . ) of said second plurality have the same tenacity as said second yarn (5″).

7. The hose as claimed in the preceding claim 6, wherein the yarns (5, 5′, 5′″, . . . ) of said first plurality are interlaced with corresponding yarns (10, 10′, 10″, 10′″, . . . ) of said second plurality to define the reinforcement layer (3), which comprises two mutually coupled knitted portions (3′, 3″), each of said knitted portions (3′, 3″) having respective wales (7, 7′, 7″, . . . ; 13, 13′, 13″, . . . ) and courses (8, 8′, 8″ . . . ; 12, 12′, 12″ . . . ), the wales (7, 7′, 7″ . . . ; 13, 13′, 13″ . . . ) of one of said knitted portions (3′, 3″) partially overlapping the wales (12, 12′, 12″ . . . ; 8, 8′, 8″ . . . ;) of the other one of said knitted portions (3″, 3′).

8. The hose as claimed in claim 7, wherein said first plurality of yarns (5, 5′, 5′″ . . . ), and sand second plurality of yarns (10, 10′, 10″, 10′″ . . . ) respectively are spiraled over the inner layer with substantially parallel wales of stitches (7, 7′, 7″ . . . ; 13, 13′, 13″ . . . ) and courses of stitches (8, 8′, 8″ . . . ; 12, 12′, 12″ . . . ), said courses of stitches (8, 8′, 8″ . . . ; 12, 12′, 12″ . . . ) and said wales (7, 7′, 7″ . . . ; 13, 13′, 13″ . . . ) being disposed with respective predetermined inclination angles (α, β; α′, β′) in relation to a longitudinal axis (Y) of the hose.

9. A method of making an irrigation hose as claimed in claim 1, comprising the steps of:
forming at least one first inner layer (2) comprising a first thermoplastic polymer material;
knitting at least one reinforcement layer (3) over said first inner layer, said reinforcement layer comprising at least one first plurality of yarns (5, 5′, 5′″ . . . ) knitted together to form a first plurality of tricot chain stitches (6, 6′, 6′″ . . . ), whereof at least one first yarn (5) comprises of a high tenacity fiber having a tenacity of at least 1500 mN/tex as measured according to EN ISO 2062 standard, and at least one second yarn (5″, 10) comprises a polyester fiber or a fiber of substantially equal tenacity, fastened to said at least one first yarn (5); and
covering said at least one reinforcement layer with a second outer layer (4) made of a second thermoplastic polymer material;
further comprising, after said knitting step, a heat shrinking step in which said at least one second yarn is shrunk over said first layer for said at least one first yarn to be put under tension by said at least one second yarn, thereby keeping said reinforcement layer adhering to said first layer.

10. The method as claimed in claim 9, wherein said heat shrinking step comprises a local heating step in which said knitted reinforcement layer associated with said first layer is locally heated.

11. The method as claimed in claim 10, wherein said local heating step is carried out by causing said knitted reinforcement layer to continuously run through a kiln having a predetermined internal temperature.

12. The method as claimed in claim 9, wherein said step of forming said first layer and said step of covering with said second layer are carried out by extrusion of the corresponding materials.
